(19) United States
(12) Patent Application Publication
(10) Pub. No.: US 2021/0012277 A1
(43) Pub. Date: Jan. 14, 2021

(54) PACKAGE SHIPPING SYSTEM BY USING CHARACTERISTIC IDENTIFIER AND METHOD THEREOF

(71) Applicant: Hye Sun SONG, Seoul (KR)

(72) Inventor: Hye Sun SONG, Seoul (KR)

(21) Appl. No.: 16/705,529

(22) Filed: Dec. 6, 2019

(30) Foreign Application Priority Data
Jul. 8, 2019 (KR) 10-2019-0081844

(51) Int. Cl. G06Q 10/08; G06Q 30/06

(52) U.S. Cl. CPC G06Q 10/0833; G06Q 30/0601; G06Q 10/0832; G06Q 10/0835; G06Q 10/0836; G06Q 10/087

(57) ABSTRACT

A package shipping system includes a tag that stores characteristic identifier and is attached to package, a smart user device that connects to management server of post office to send user and recipient information, receives the characteristic identifier from the management server, and saves characteristic identifier onto the tag, the management server that receives user and recipient information, generates the characteristic identifier, matches user information, recipient information and characteristic identifier information, sends characteristic identifier information to the smart user device, receives characteristic identifier information from a smart device of a designated shipper, and sends recipient's address information matching the characteristic identifier information to the smart device, and the smart device that communicates with the tag attached to the package classified according to target delivery area, receives and saves characteristic identifier information, sends saved characteristic identifier information to the management server, and receives recipient's address information from the management server.

### CROSS-REFERENCE TO RELATED APPLICATION

This application claims priority to Korean Patent Application No.

10-2019-0081844, filed Jul. 8, 2019, the entire content of which is hereby incorporated by reference.

### BACKGROUND

### 1. Field of the Invention

This invention relates to a package shipping system by using characteristic identifier and the method thereof. This system allows shippers to deliver easily without indicating the address, postal code and phone number of the sender and recipient on the outer cover of the package wrapper containing a package like postal mail or product purchased from an online shopping mall.

### 2. Description of Related Art

The conventional art related to this invention is disclosed by Korean Patent Application Publication No. 10-2018-0023316 (disclosed on Mar. 7, 2018). FIG. 1 is the block diagram of the conventional identifier-based package shipping system. In FIG. 1, the conventional identifier-based package shipping system may include service provider devices (100), service server (20) and customer device (10). The service provider devices (100) refer to devices that can scan an identifier and read information of the scanned identifier. In addition, the service provider devices (100) may include a computer processor (112), memory (113), display area (114), hardware and software (115), camera (116) and service application (not included in the figure) according to an embodiment. Here, the application is sometimes called the app, and the terms ‘application’ and ‘app’ are used to mean the same in this specification. In addition, the service application is embodied as a program command to be executed via various computer means to execute the identifier-based package shipping service and may be recorded onto a computer medium combined with hardware of the service provider device (100). In addition, the service provider devices (100) can be made into different devices that include a computer processor (112), for instance a PC (Personal Computer), smartphone, smart watch, tablet PC, PDA phone or laptop, memory (113), display area (114), hardware and software (115) and camera (166) for scanning of identifier. Here, the smartphone refers to a mobile phone that offers the same functions as a PC and additional advanced functions. The smart watch refers to an embedded watch that has improved functions compared to ordinary watch. The tablet PC is a portable PC that uses a touchscreen as the main input device. The PDA phone refers to a PDA (Personal Digital Assistant) mounted with a telecommunication module. Here, a software program [0048] that is run under control of the computer processor (112) is saved in the memory (113). The display area (114) may be embodied into a device like monitor, and hardware and software (115) collectively refer to additional components needed to operate the service provider devices (100). The service provider devices (100) include the registration team device (110) to register the package, the shi3pping team device (120) to deliver the package to the destination, and the receiving team device (130) of the team that receives the package. The registration team device (110) scans the identifier attached to the package, matches shipping information with scanned identifier information, and performs the registration step of saving information as registration information on the customer DB (30). The shipping team device (120) scans the identifier attached to the package after registration is completed by the registration team device (110) and sends scanned identifier information and current shipping status information to the service server (20). The receiving team device (130) scans the identifier attached to the package received from the shipping team and sends scanned identifier information and current shipping status information of the package to the service server (20). According to an embodiment, the service provider devices (100) may include a reader to recognize the identifier. The reader can be embodied into a device separated from the service provider devices (100) or an embedded device included in the service provider devices (100). For instance, the reader embedded in the registration team device (110) scans the identifier attached to the package and recognizes scanned identifier information. The reader embedded in the shipping team device (120) scans the identifier attached to the package received from the registration team and recognizes scanned identifier information. The reader embedded in the receiving team device (130) scans the identifier attached to the package received from the shipping team and recognizes scanned identifier information. The service server (20) saves and manages the service application according to an embodiment of this invention and can send the customer service application to a customer device (10) when a download request is received from the customer device (10). The service server (20) may include a program that executes the identifier-based package shipping service according to this invention (hereinafter referred to as the ‘service program’). In addition, the service program is embodied into a program command to be executed via various computer means to execute the identifier-based package shipping service and may be recorded onto a computer medium combined with hardware of the service server (20). According to an embodiment, the service server (20) updates registration information matched with identifier information received from the service provider devices (100) as shipping status information of the package received from the shipping team device (120). For instance, when the service server (20) receives identifier information and current shipping status information from the shipping team device (120), it finds registration information of the package that matches identifier information received and updates shipping status information of the package by referring to current shipping status information received. For another instance, when the service server (20) receives identifier information and current shipping status information of the package from the receiving team device (130), it finds registration information of the package that matches identifier information received and updates shipping status information of the package by referring to current shipping status information received. In other words, the service server (20) updates shipping status information of the package whenever it receives current shipping status information of the package from the shipping team device (120) or receiving team device (130).

### SUMMARY OF THE INVENTION

The conventional art consisting of the above saves all of shipping information onto the tag attached to the package, requiring a tag with large memory. Illegal scanning of the tag can result in illegal hacking of personal information such as address, phone number and name. In addition, the conventional art scans the tag and sends tag information to the server. Since the registration team device, shipping team device and receiving team device scan tag information and send it to the server every time to inform current status of the package, the conventional art causes unnecessary traffic and inefficiency issue. Therefore, the purpose of this invention is to minimize information saved on the tag attached to the package so as to prevent leakage of information in the case of hacking. In addition, another purpose of this invention is for users to conveniently use the package shipping system by removing the need to record information on the outer cover of the package. This invention is also intended to help shippers deliver packages smoothly using a smart device and the tag attached to the packages.

The package shipping system of this invention based on characteristic identifier with the purposes is characterized by a tag (210) that stores a characteristic identifier and is attached to the package, a smart user device (220) that connects to the management server of the post office to send user information and recipient information for creation of DB, receives the characteristic identifier from the management server of the post office, and saves the characteristic identifier onto the tag by communicating with the tag, a management server of the post office (230) that receives user information and recipient information from the smart user device, generates the characteristic identifier, matches user information, recipient information and characteristic identifier information to create DB, sends characteristic identifier information to the smart user device, receives characteristic identifier information saved on the tag from the smart device of the designated shipper, and sends recipient's address information matched with characteristic identifier information to the smart device of the shipper, and a smart device of the shipper (240) that communicates with the tag attached to the package classified according to the target delivery area, receives and saves characteristic identifier information from the tag, sends saved characteristic identifier information to the management server of the post office, and receives recipient's address information from the management server of the post office. In the above, the characteristic identifier can be comprised of number information, photo information and combination of letters and numbers like a password. The tag may be an NFC tag, RFID, QR code, etc.

### Advantageous Effects

The package shipping system of this invention based on characteristic identifier comprised of the above and the method thereof have an effect of concealing shipping information such as address, phone number and name from third persons by simply attaching the identifier tag to the package. In addition, since this invention ships packages based upon the identifier issued by the management server of the post office, the system offers convenient shipping and has great adaptability by issuing multiple identifiers when shipping packages to many recipients. This invention also has an effect of efficiently shipping packages without errors by shipping based on the system.

### BRIEF DESCRIPTION OF THE DRAWINGS

FIG. 1 is the block diagram of the conventional identifier-based package shipping system.

FIG. 2 is the block diagram of the 1st embodiment for the package shipping system of this invention using characteristic identifier.

FIG. 3 is the block diagram of the 2nd embodiment for the package shipping system of this invention using characteristic identifier.

FIG. 4 is the control flow diagram of the 1st embodiment for the package shipping system of this invention using characteristic identifier.

FIG. 5 is the control flow diagram of the 2nd embodiment for the package shipping system of this invention using characteristic identifier.

FIG. 6 is the control flow diagram of the 3rd embodiment for the package shipping system of this invention using characteristic identifier.

FIG. 7 is the control flow diagram of the 4th embodiment for the package shipping system of this invention using characteristic identifier.

FIG. 8 is the control flow diagram of the 5th embodiment for the package shipping system of this invention using characteristic identifier.

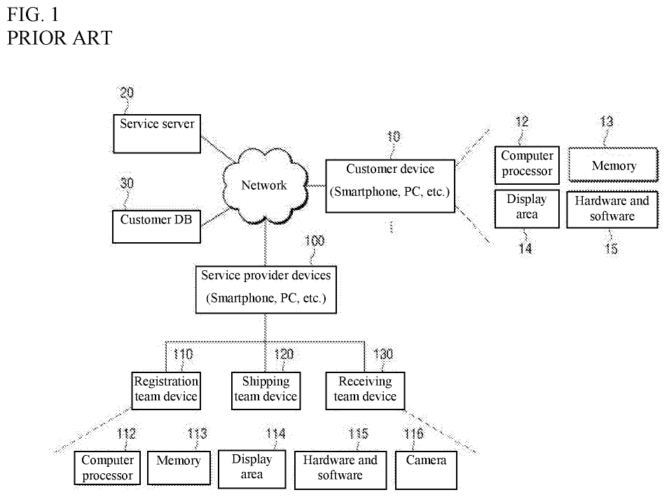

### DETAILED DESCRIPTION OF THE INVENTION

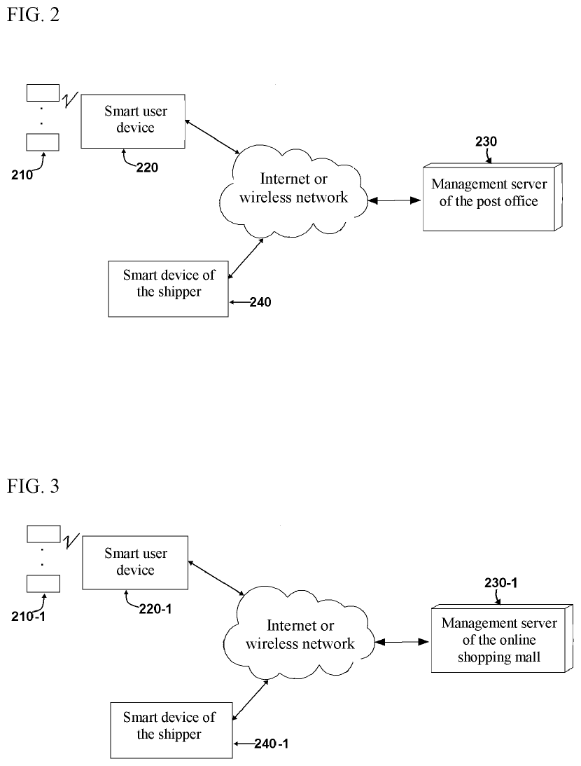

The package shipping system of this invention based on characteristic identifier comprised of the above and the method thereof with the purposes can be explained as below based upon FIGS. 2 through 5.

FIG. 2 is the block diagram of the 1st embodiment for the package shipping system of this invention using characteristic identifier. In FIG. 2, the 1st embodiment for the package shipping system of this invention using characteristic identifier is characterized by a tag (210) that stores a characteristic identifier and is attached to the package, a smart user device (220) that connects to the management server of the post office to send user information and recipient information for creation of DB, receives the characteristic identifier from the management server of the post office, and saves the characteristic identifier onto the tag by communicating with the tag, a management server of the post office (230) that receives user information and recipient information from the smart user device, generates the characteristic identifier, matches user information, recipient information and characteristic identifier information to create DB, sends characteristic identifier information to the smart user device, receives characteristic identifier information saved on the tag from the smart device of the designated shipper, and sends recipient's address information matched with characteristic identifier information to the smart device of the shipper, and a smart device of the shipper (240) that communicates with the tag attached to the package classified according to the target delivery area, receives and saves characteristic identifier information from the tag, sends saved characteristic identifier information to the management server of the post office, and receives recipient's address information from the management server of the post office. In the above, the characteristic identifier can be comprised of number information, photo information and combination of letters and numbers like a password. The tag may be an NFC tag, RFID, QR code, etc. In the above, the tag (210), smart user device (220) and smart device of the shipper (230) support local area communication modules.

FIG. 3 is the block diagram of the 2nd embodiment for the package shipping system of this invention using characteristic identifier. In FIG. 3, the 2nd embodiment for the package shipping system of this invention using characteristic identifier relates to shipping of a product purchased on an online shopping mall and is characterized by a tag (210-1) that receives and stores a characteristic identifier by communicating with the smart device of the shipper and is attached to the purchased product, a smart user device (220-1) that connects to the management server of the online shopping mall, provides purchaser information such as name, address and phone number, and purchases the product, a management server of the online shopping mall (230-1) that creates DB using purchaser information and product information provided by the smart user device, generates characteristic identifier information about the purchased product, and sends characteristic identifier information, product information and recipient information to the smart device of the shipper, and a smart device of the shipper (240-1) that receives and stores characteristic identifier information, product information and recipient information from the management server of the online shopping mall, saves characteristic identifier information on the tag by communicating with the tag, and provides recipient's address information through the display area. In the above, the smart device of the shipper (240-1) receives position information from the GPS satellite upon arrival of recipient position information, receives characteristic identifier information by communicating with the tag attached to the purchased product, confirms matching of recipient's address with characteristic identifier information and position information, and delivers the purchased product to the recipient if information is matched. In addition, the smart device of the shipper can be guided to recipient's address by receiving path information in connection with navigation programs such as T Map. In the above, if the recipient is the same as the purchaser, purchaser information becomes recipient information. If the recipient is not the same as the purchaser, the smart user device can provide recipient information such as address, name and phone number of the recipient upon purchase.

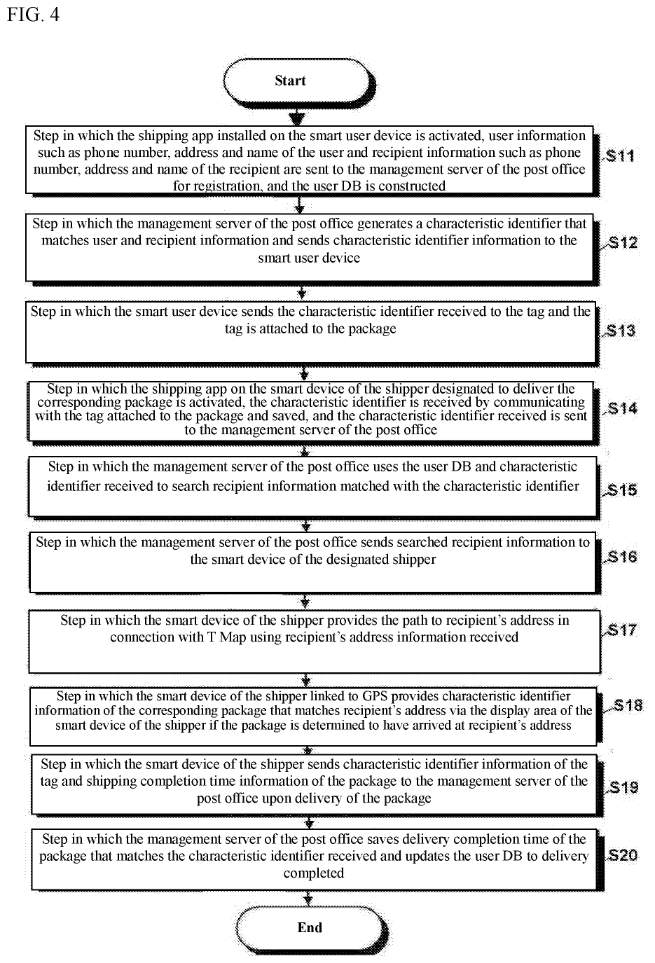

FIG. 4 is the control flow diagram of the 1st embodiment for the package shipping system of this invention using characteristic identifier. In FIG. 4, the 1st embodiment for the package shipping method of this invention using characteristic identifier is characterized by a step (S11) in which the shipping app installed on the smart user device is activated, user information such as phone number, address and name of the user and recipient information such as phone number, address and name of the recipient are sent to the management server of the post office for registration, and the user DB is constructed, a step (S12) in which the management server of the post office generates a characteristic identifier that matches user and recipient information and sends characteristic identifier information to the smart user device, a step (S13) in which the smart user device sends the characteristic identifier received to the tag and the tag is attached to the package, a step (S14) in which the shipping app on the smart device of the shipper designated to deliver the corresponding package is activated, the characteristic identifier is received by communicating with the tag attached to the package and saved, and the characteristic identifier received is sent to the management server of the post office, a step (S15) in which the management server of the post office uses the user DB and characteristic identifier received to search recipient information matched with the characteristic identifier, a step (S16) in which the management server of the post office sends searched recipient information to the smart device of the designated shipper, a step (S17) in which the smart device of the shipper provides the path to recipient's address in connection with T Map using recipient's address information received, a step (S18) in which the smart device of the shipper linked to GPS provides characteristic identifier information of the corresponding package that matches recipient's address via the display area of the smart device of the shipper if the package is determined to have arrived at recipient's address, a step (S19) in which the smart device of the shipper sends characteristic identifier information of the tag and shipping completion time information of the package to the management server of the post office upon delivery of the package, and a step (20) in which the management server of the post office saves delivery completion time of the package that matches the characteristic identifier received and updates the user DB to delivery completed. In addition, the embodiment is characterized by an additional step (S19-1) after S19 in which the management server of the post office searches recipient's address information that matches characteristic identifier information received based on the characteristic identifier and verifies whether the corresponding package was delivered to the corresponding recipient. In addition, the step (S17) in which the smart device of the shipper provides the path to recipient's address in connection with T Map using recipient's address information received can sequentially provide recipient information via T Map based on the current position of the smart device of the shipper if the smart device of the shipper receives multiple recipient addresses to deliver multiple packages. In addition, the step (S18) in which the smart device of the shipper linked to GPS provides characteristic identifier information of the corresponding package that matches recipient's address via the display area of the smart device of the shipper if the package is determined to have arrived at recipient's address may have the smart device of the shipper search recipient's address information based on position information, communicate with the tag attached to the package, and find and deliver the package storing characteristic identifier information that matches recipient's address searched. In addition, the characteristic identifier may be an alias number. Generally, one characteristic identifier is granted to one package. A characteristic identifier may be issued by matching one user who wishes to send a package and one recipient who wishes to receive the package. If there is one user who wishes to send packages and multiple recipients, the number of characteristic identifiers issued can be identical to the number of recipients. The user and recipient may each be issued with a characteristic identifier, and the characteristic identifier can include photo information like photos of the package. In addition, the step (S15) in which the management server of the post office uses the user DB and characteristic identifier received to search recipient information matched with the characteristic identifier can have the management server search address and phone number of the recipient and provide user information for the corresponding package or shipping position information for the package to phone number information searched. In the above, package shipping position information can provide current position information or delivery completion information of the package and delivery completion time information by combining characteristic identifier information of the package, position information sent by the smart device of the shipper, delivery completion information, and delivery completion time information In addition, if multiple packages are shipped to multiple recipients or the same package is shipped to multiple recipients in S12, S11 can have the smart user device send multiple recipient information to the management server of the post office and S12 can generate the same number of characteristic identifiers as the number of recipients to be sent to the smart user device.

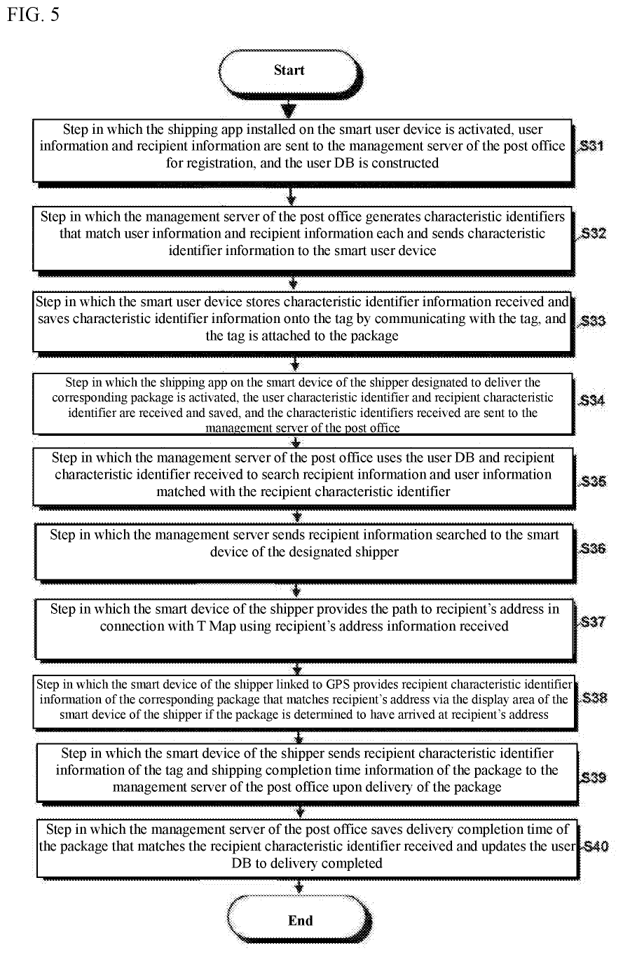

FIG. 5 is the control flow diagram of the 2nd embodiment for the package shipping system of this invention using characteristic identifier. The 2nd embodiment for the package shipping method of this invention using characteristic identifier is characterized by a step (S31) in which the shipping app installed on the smart user device is activated, user information such as phone number, address and name of the user and recipient information such as phone number, address and name of the recipient are sent to the management server of the post office for registration, and the user DB is constructed, a step (S32) in which the management server of the post office generates characteristic identifiers that match user information and recipient information each and sends characteristic identifier information to the smart user device, a step (S33) in which the smart user device stores characteristic identifier information received and saves characteristic identifier information onto the tag by communicating with the tag, and the tag is attached to the package, a step (S34) in which the shipping app on the smart device of the shipper designated to deliver the corresponding package is activated, the user characteristic identifier and recipient characteristic identifier are received and saved, and the characteristic identifiers received are sent to the management server of the post office, a step (S35) in which the management server of the post office uses the user DB and recipient characteristic identifier received to search recipient information and user information matched with the recipient characteristic identifier, a step (S36) in which the management server sends recipient information searched to the smart device of the designated shipper, a step (S37) in which the smart device of the shipper provides the path to recipient's address in connection with T Map using recipient's address information received, a step (S38) in which the smart device of the shipper linked to GPS provides recipient characteristic identifier information of the corresponding package that matches recipient's address via the display area of the smart device of the shipper if the package is determined to have arrived at recipient's address, a step (S39) in which the smart device of the shipper sends recipient characteristic identifier information of the tag and shipping completion time information of the package to the management server of the post office upon delivery of the package, and a step (S40) in which the management server of the post office saves delivery completion time of the package that matches the recipient characteristic identifier received and updates the user DB to delivery completed. In addition, the embodiment is characterized by an additional step (S39-1) after S39 in which the management server of the post office searches recipient's address information that matches recipient characteristic identifier information received based on the recipient characteristic identifier received and verifies whether the corresponding package was delivered to the corresponding recipient. In the above, S36 can also send user information with recipient information to the smart device of the shipper if necessary.

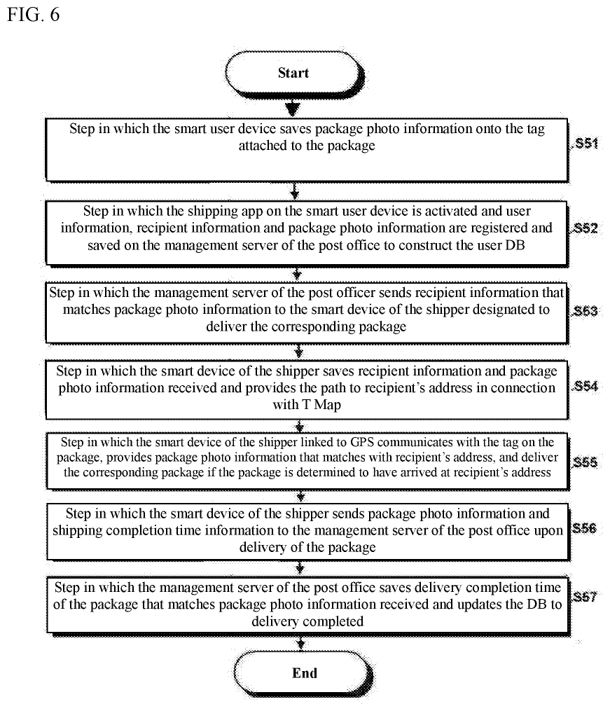

FIG. 6 is the control flow diagram of the 3rd embodiment for the package shipping system of this invention using characteristic identifier. The 3rd embodiment for the package shipping method of this invention using characteristic identifier is characterized by a step (S51) in which the smart user device saves package photo information onto the tag attached to the package, a step (S52) in which the shipping app on the smart user device is activated and user information such as phone number, address and name of the user, recipient information such as phone number, address and name of the recipient, and package photo information are registered and saved on the management server of the post office to construct the user DB, a step (S53) in which the management server of the post officer sends recipient information that matches package photo information to the smart device of the shipper designated to deliver the corresponding package, a step (S54) in which the smart device of the shipper saves recipient information and package photo information received and provides the path to recipient's address in connection with T Map, a step (S55) in which the smart device of the shipper linked to GPS communicates with the tag on the package, provides package photo information that matches with recipient's address, and deliver the corresponding package if the package is determined to have arrived at recipient's address, a step (S56) in which the smart device of the shipper sends package photo information and shipping completion time information to the management server of the post office upon delivery of the package, and a step (S57) in which the management server of the post office saves delivery completion time of the package that matches package photo information received and updates the DB to delivery completed. In addition, in S55, the smart device continues to communicate with tags attached to other packages and finds photo information of the corresponding package to be provided on the display area if the package does not match recipient's address. In the above, package photo information is characteristic identifier information in the form of a photo.

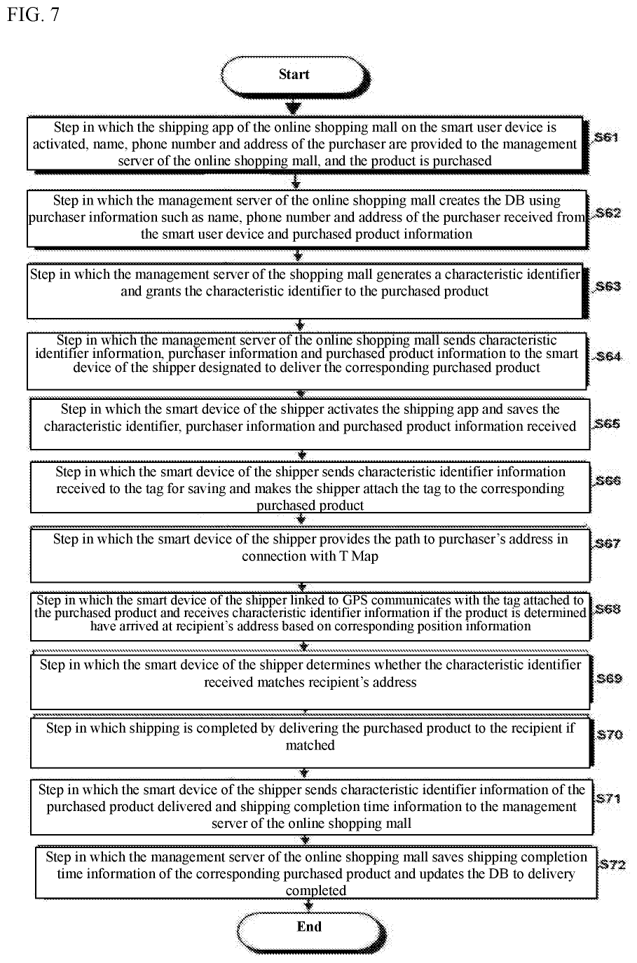

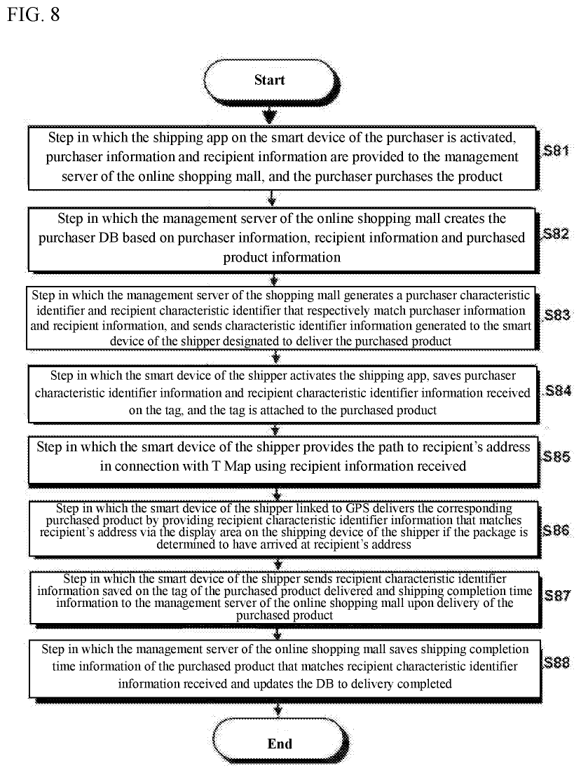

FIG. 7 is the control flow diagram of the 4th embodiment for the package shipping system of this invention using characteristic identifier. In FIG. 7, the 4th embodiment for the package shipping method of this invention using characteristic identifier is an embodiment for which the package is received at purchaser's address because the purchaser is the same as the recipient. Accordingly, the 4th embodiment for the package shipping system of this invention using characteristic identifier in FIG. 7 is characterized by a step (S61) in which the shipping app of the online shopping mall on the smart user device is activated, name, phone number and address of the purchaser are provided to the management server of the online shopping mall, and the product is purchased, a step (S62) in which the management server of the online shopping mall creates the DB using purchaser information such as name, phone number and address of the purchaser received from the smart user device and purchased product information, a step (S63) in which the management server of the online shopping mall creates a characteristic identifier and grants the characteristic identifier to the purchased product, a step (S64) in which the management server of the online shopping mall sends characteristic identifier information, purchaser information and purchased product information to the smart device of the shipper designated to deliver the corresponding purchased product, a step (S65) in which the smart device of the shipper activates the shipping app and saves the characteristic identifier, purchaser information and purchased product information received, a step (S66) in which the smart device of the shipper sends characteristic identifier information received to the tag for saving and makes the shipper attach the tag to the corresponding purchased product, a step (S67) in which the smart device of the shipper provides the path to purchaser's address in connection with T Map, a step (S68) in which the smart device of the shipper linked to GPS communicates with the tag attached to the purchased product and receives characteristic identifier information if the product is determined have arrived at recipient's address based on corresponding position information, a step (S69) in which the smart device of the shipper determines whether the characteristic identifier received matches recipient's address, a step (S70) in which shipping is completed by delivering the purchased product to the recipient if matched, a step (S71) in which the smart device of the shipper sends characteristic identifier information of the purchased product delivered and shipping completion time information to the management server of the online shopping mall, and a step (S72) in which the management server of the online shopping mall saves shipping completion time information of the corresponding purchased product and updates the DB to delivery completed. In the above, the characteristic identifier may be an alias number, photo information or password information. In addition, in S63, the characteristic identifier can be granted to each product if there are many purchased products or a single characteristic identifier is granted to the entire packing if all purchased products are packed into a package. In addition, S67 may be omitted if the shipper uses public transportation means such as subway and bus. In addition, if the characteristic identifier does not match information in S69, the smart device of the shipper continues the procedure of communicating with tags attached to other purchased products possessed by the shipper and finds the corresponding purchased product that matches position information (recipient's address information) for delivery of the product to the recipient. In addition, the management server of the online shopping mall can search address information and phone number information of the recipient to provide purchaser information or position information of the corresponding purchased product via phone number information searched. Shipping position information of the purchased product can be combined with position information sent by the smart device of the shipper based on characteristic identifier information saved on the tag attached to the purchased product to provide current position information of the purchased product or shipping completion information and shipping completion time information to the purchaser and recipient.

FIG. 8 is the 5th embodiment for the package shipping method of this invention using characteristic identifier. In FIG. 8, the 5th embodiment for the package shipping method of this invention using characteristic identifier is an embodiment for which the product purchaser of an online shopping mall differs from the product recipient. In FIG. 8, the 5th embodiment for the package shipping method of this invention using characteristic identifier is characterized by a step (S81) in which the shipping app on the smart device of the purchaser is activated, purchaser information such as phone number, address and name of the purchaser and recipient information such as phone number, address and name of the recipient are provided to the management server of the online shopping mall, and the purchaser purchases the product, a step (S82) in which the management server of the online shopping mall creates the purchaser DB based on purchaser information, recipient information and purchased product information, a step (S83) in which the management server of the shopping mall generates a purchaser characteristic identifier and recipient characteristic identifier that respectively match purchaser information and recipient information, and sends characteristic identifier information generated to the smart device of the shipper designated to deliver the purchased product, a step (S84) in which the smart device of the shipper activates the shipping app, saves purchaser characteristic identifier information and recipient characteristic identifier information received on the tag, and the tag is attached to the purchased product, a step (S85) in which the smart device of the shipper provides the path to recipient's address in connection with T Map using recipient information received, a step (S86) in which the smart device of the shipper linked to GPS delivers the corresponding purchased product by providing recipient characteristic identifier information that matches recipient's address via the display area on the shipping device of the shipper if the package is determined to have arrived at recipient's address, a step (S87) in which the smart device of the shipper sends recipient characteristic identifier information saved on the tag of the purchased product delivered and shipping completion time information to the management server of the online shopping mall upon delivery of the purchased product, and a step (S88) in which the management server of the online shopping mall saves shipping completion time information of the purchased product that matches recipient characteristic identifier information received and updates the DB to delivery completed. In addition, the embodiment is characterized by an additional step (S87-1) after S87 in which the management server of the online shopping mall searches recipient's address information that matches characteristic identifier information received based on characteristic identifier information received to verify whether the corresponding purchased product was delivered to the corresponding recipient. In addition, if there are multiple tags attached to the purchased product in S86, the smart device of the shipper communicates with the tags in order, finds the product attached with the tag storing characteristic identifier information that matches corresponding recipient's address, and provides characteristic identifier information using the display area.

What is claimed is:

1. A package shipping system using a characteristic identifier that does not require user information and recipient information to be written on a package, the package shipping system comprising:
a tag (210) that stores a characteristic identifier and is attached to the package;
a smart user device (220) that connects to the management server of the post office to send user information and recipient information for creation of DB, receives the characteristic identifier from the management server of the post office, and saves the characteristic identifier onto the tag by communicating with the tag;
a management server of the post office (230) that receives user information and recipient information from the smart user device, generates the characteristic identifier, matches user information, recipient information and characteristic identifier information to create DB, sends characteristic identifier information to the smart user device, receives characteristic identifier information saved on the tag from the smart device of the designated shipper, and sends recipient's address information matched with characteristic identifier information to the smart device of the shipper; and
a smart device of the shipper (240) that communicates with the tag attached to the package classified according to the target delivery area, receives and saves characteristic identifier information from the tag, sends saved characteristic identifier information to the management server of the post office, and receives recipient's address information from the management server of the post office.

2. A shopping mall shipping system using a characteristic identifier that does not require a purchaser's address to be written, the shopping mall shipping system comprising:
a tag (210-1) that receives and stores a characteristic identifier by communicating with the smart device of the shipper and is attached to the purchased product;
a smart user device (220-1) that connects to the management server of the online shopping mall, provides purchaser information such as name, address and phone number, and purchases the product;
a management server of the online shopping mall (230-1) that creates DB using purchaser information and product information provided by the smart user device, generates characteristic identifier information about the purchased product, and sends characteristic identifier information, product information and recipient information to the smart device of the shipper; and
a smart device of the shipper (240-1) that receives and stores characteristic identifier information, product information and recipient information from the management server of the online shopping mall, saves characteristic identifier information on the tag by communicating with the tag, and provides recipient's address information through the display area.

3. A package shipping method using a characteristic identifier that does not require address to be written, the package shipping method comprising:
a step (S11) in which the shipping app installed on the smart user device is activated, user information such as phone number, address and name of the user and recipient information such as phone number, address and name of the recipient are sent to the management server of the post office for registration, and the user DB is constructed;
a step (S12) in which the management server of the post office generates a characteristic identifier that matches user and recipient information and sends characteristic identifier information to the smart user device;
a step (S13) in which the smart user device sends the characteristic identifier received to the tag and the tag is attached to the package;
a step (S14) in which the shipping app on the smart device of the shipper designated to deliver the corresponding package is activated, the characteristic identifier is received by communicating with the tag attached to the package and saved, and the characteristic identifier received is sent to the management server of the post office;
a step (S15) in which the management server of the post office uses the user DB and characteristic identifier received to search recipient information matched with the characteristic identifier;
a step (S16) in which the management server of the post office sends searched recipient information to the smart device of the designated shipper; and
a step (S18) in which the smart device of the shipper linked to GPS provides characteristic identifier information of the corresponding package that matches recipient's address via the display area of the smart device of the shipper if the package is determined to have arrived at recipient's address.

4. The package shipping method of claim 3, further comprising a step in which the smart device of the shipper provides the path to recipient's address in connection with T Map based on recipient's address information received.

5. A package shipping method using a characteristic identifier that does not require address to be written, the package shipping method comprising:
a step (S31) in which the shipping app installed on the smart user device is activated, user information and recipient information are registered on the management server of the post office, and the user DB is constructed;
a step (S32) in which the management server of the post office generates characteristic identifiers that match user information and recipient information each and sends characteristic identifier information to the smart user device;
a step (S33) in which the smart user device stores characteristic identifier information received and saves characteristic identifier information onto the tag by communicating with the tag, and the tag is attached to the package;
a step (S34) in which the shipping app on the smart device of the shipper designated to deliver the corresponding package is activated, the user characteristic identifier and recipient characteristic identifier are received and saved, and the characteristic identifiers received are sent to the management server of the post office;
a step (S35) in which the management server of the post office uses the user DB and recipient characteristic identifier received to search recipient information and user information matched with the recipient characteristic identifier;
a step (S36) in which the management server sends recipient information searched to the smart device of the designated shipper; and
a step (S38) in which the smart device of the shipper linked to GPS provides recipient characteristic identifier information of the corresponding package that matches recipient's address via the display area of the smart device of the shipper if the package is determined to have arrived at recipient's address.

6. The package shipping method of claim 5, further comprising a step in which the smart device of the shipper provides the path to recipient's address in connection with T Map based on recipient's address information received.

7. A package shipping method using a characteristic identifier that does not require address to be written, the package shipping method comprising:
a step (S51) in which the smart user device saves package photo information onto the tag attached to the package;
a step (S52) in which the shipping app on the smart user device is activated and user information, recipient information and package photo information are registered and saved on the management server of the post office to construct the user DB;
a step (S53) in which the management server of the post officer sends recipient information that matches package photo information to the smart device of the shipper designated to deliver the corresponding package; and
a step (S55) in which the smart device of the shipper linked to GPS communicates with the tag on the package, provides package photo information that matches with recipient's address, and deliver the corresponding package if the package is determined to have arrived at recipient's address.

8. The package shipping method of claim 7, further comprising a step in which the smart device of the shipper provides the path to recipient's address in connection with T Map based on recipient's address information received.

9. A shopping mall shipping method using a characteristic identifier that does not require address to be written, the shopping mall shipping method comprising:
a step (S61) in which the shipping app of the online shopping mall on the smart user device is activated, name, phone number and address of the purchaser are provided to the management server of the online shopping mall, and the product is purchased;
a step (S62) in which the management server of the online shopping mall creates the DB using purchaser information such as name, phone number and address of the purchaser received from the smart user device and purchased product information;
a step (S63) in which the management server of the online shopping mall creates a characteristic identifier and grants the characteristic identifier to the purchased product;
a step (S64) in which the management server of the online shopping mall sends characteristic identifier information, purchaser information and purchased product information to the smart device of the shipper designated to deliver the corresponding purchased product;
a step (S65) in which the smart device of the shipper activates the shipping app and saves the characteristic identifier, purchaser information and purchased product information received;
a step (S66) in which the smart device of the shipper sends characteristic identifier information received to the tag for saving and makes the shipper attach the tag to the corresponding purchased product;
a step (S68) in which the smart device of the shipper linked to GPS communicates with the tag attached to the purchased product and receives characteristic identifier information if the product is determined have arrived at recipient's address based on corresponding position information;
a step (S69) in which the smart device of the shipper determines whether the characteristic identifier received matches recipient's address; and
a step (S70) in which shipping is completed by delivering the purchased product to the recipient if matched.

10. The shopping mall shipping method of claim 9, further comprising a step in which the smart device of the shipper provides the path to purchaser's address in connection with T Map.

11. A shopping mall shipping method using a characteristic identifier that does not require address to be written, the shopping mall shipping method comprising:
a step (S81) in which the shipping app on the smart device of the purchaser is activated, purchaser information and recipient information are provided to the management server of the online shopping mall, and the purchaser purchases the product;
a step (S82) in which the management server of the online shopping mall creates the purchaser DB based on purchaser information, recipient information and purchased product information;
a step (S83) in which the management server of the shopping mall generates a purchaser characteristic identifier and recipient characteristic identifier that respectively match purchaser information and recipient information, and sends characteristic identifier information generated to the smart device of the shipper designated to deliver the purchased product;
a step (S84) in which the smart device of the shipper activates the shipping app, saves purchaser characteristic identifier information and recipient characteristic identifier information received on the tag, and the tag is attached to the purchased product; and
a step (S86) in which the smart device of the shipper linked to GPS delivers the corresponding purchased product by providing recipient characteristic identifier information that matches recipient's address via the display area on the shipping device of the shipper if the package is determined to have arrived at recipient's address.

12. The shopping mall shipping method of claim 11, further comprising a step in which the smart device of the shipper provides the path to recipient's address in connection with T Map.
